(19) United States
(12) Patent Application Publication
(10) Pub. No.: US 2008/0134264 A1
(43) Pub. Date: Jun. 5, 2008

(54) METHOD AND APPARATUS FOR INTERACTIVITY WITH BROADCAST MEDIA

(75) Inventors: Patrenahalli M. Narendra, Barrington, IL (US); Dragan M. Boscovic, South Barrington, IL (US); Gary L. DeGregorio, Sleepy Hollow, IL (US); Mark M. Thomson, Lake Zurich, IL (US); John G. Waclawsky, Bartlett, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/565,357

(22) Filed: Nov. 30, 2006

(51) Int. Cl. H04N 7/173

(52) U.S. Cl. 725/110

(57) ABSTRACT

A method and apparatus for interactivity with broadcast media is provided. The method includes capturing (404) a plurality of audio segments from a plurality of broadcasts. The plurality of broadcasts correspond to a plurality of broadcast channels. Further, the method includes receiving (406) an audio clip from an electronic device (200). The method also includes identifying (408) a broadcast channel corresponding to the audio clip based on the plurality of audio segments and the audio clip.

### FIELD OF THE INVENTION

The present invention relates generally to the field of broadcast media, and more particularly, to a method and system for interactivity with broadcast media.

### BACKGROUND

With the increase in the variety of content being broadcast, broadcast media has become an important part of people's lives. Broadcast content, for example, music, news, and product advertisements, increases the popularity of broadcast media. However, in spite of broadcast media being popular, there has been negligible advancement in techniques that enable users to interact with the broadcast media.

Currently, there exist various techniques by means of which broadcast content can be used to interact with database servers. One of the existing techniques provides a method for buying a music clip. In this technique, an audio clip for the song to be bought can be captured by using an electronic device and sent to a server, where the audio clip is correlated with the existing songs stored on the server, to identify the song corresponding to the audio clip. This technique enables a user to buy the song that contains the audio clip. However, this technique requires a large number of complete songs or associated preprocessed information to be stored on the server. Further, this technique does not allow the user to obtain the details corresponding to the audio clip from the broadcast channel. For example, if the audio clip is a portion of a product advertisement, this technique does not allow the user to obtain information about the product or buy the product. Furthermore, this technique does not work with live content, for example, news or talk shows, as preprocessing of the live content is required prior to applying this technique on it.

Another such technique is used for identifying a broadcast channel to gauge size of audience of the broadcast channel. In this technique, inaudible signals, called audio watermarks, are inserted into broadcast content prior to it being broadcast. A device that is capable of detecting the inaudible signals is used to identify the broadcast channel a user is listening to or viewing. The number of people listening to or watching that broadcast channel can be determined, based on the number of devices identifying the broadcast channel. However, this technique requires modification of the broadcast content. Further, this technique also requires specialized devices that are capable of detecting the audio watermarks.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate the embodiments and explain various principles and advantages, in accordance with the present invention.

FIG. 1 is an exemplary network where some embodiments of the present invention can be practiced;

FIG. 2 is a block diagram illustrating an exemplary media correlation server, in accordance with some embodiments of the present invention;

FIG. 3 is a block diagram illustrating an exemplary electronic device, in accordance with some embodiments of the present invention;

FIG. 4 is a chart illustrating a correlation of an audio clip with a plurality of audio segments, in accordance with some embodiments of the present invention;

FIG. 5 is a flow diagram illustrating a method for interactivity with broadcast media, in accordance with an embodiment of the present invention;

FIG. 6 is a flow diagram illustrating a method for interactivity with the broadcast media, in accordance with another embodiment of the present invention; and

FIG. 7 is a flow diagram illustrating a method for interactivity with the broadcast media, in accordance with yet another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to interactivity with broadcast media. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

In an embodiment, a method for interactivity with broadcast media is provided. The method includes capturing a plurality of audio segments from a plurality of broadcasts that correspond to a plurality of broadcast channels. Further, the method includes receiving an audio clip from an electronic device. The method also includes identifying a broadcast channel corresponding to the audio clip, based on the plurality of audio segments and the audio clip when a correspondence between the audio clip and the broadcast channel is already unknown. Further, the method includes associating the broadcast channel with the audio clip when the correspondence between the audio clip and the broadcast channel is already known.

In another embodiment, a method for interactivity with the broadcast media is provided. The method includes capturing an audio clip of a broadcast that corresponds to a broadcast channel of a plurality of broadcast channels. Further, the method includes transmitting the audio clip to a predefined destination.

In yet another embodiment, a media correlation server for interactivity with the broadcast media is provided. The media correlation server includes a receiver that is capable of receiving an audio clip from an electronic device. Further, the media correlation server includes a processing unit that is operatively coupled to the receiver. The processing unit captures a plurality of audio segments from a plurality of broadcasts that correspond to a plurality of broadcast channels. Further, the processor identifies a broadcast channel corresponding to the audio clip, based on the plurality of audio segments and the audio clip.

In yet another embodiment, an electronic device for interactivity with the broadcast media is provided. The electronic device includes a capturing unit to capture an audio clip of a broadcast that corresponds to a broadcast channel of a plurality of broadcast channels. Further, the electronic device includes a transmitter that is configured to transmit the audio clip to a predefined destination.

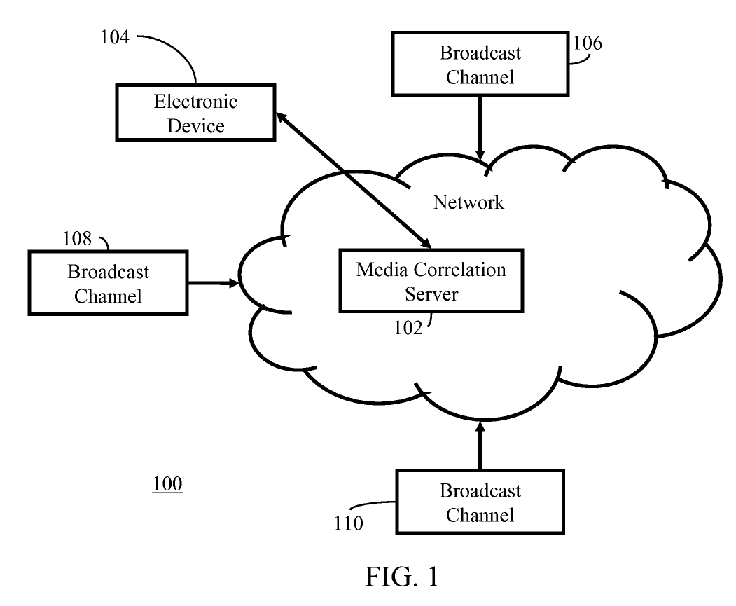

FIG. 1 is an exemplary network 100 where some embodiments of the present invention can be practiced. The network 100 includes a plurality of broadcast channels and a plurality of devices that utilize content being broadcast on the plurality of broadcast channels. Examples of broadcast channels include, but are not limited to, an Amplitude Modulated (AM) radio channel, a Frequency Modulated (FM) radio channel, iRadio, a Satellite Radio channel, High Definition (HD) radio channel, an on-air television broadcast, a cable television, and satellite television. For the purpose of this description, the network 100 is shown to include a media correlation server 102, an electronic device 104, and the plurality of broadcast channels 106, 108, and 110. Each broadcast channel of the plurality of broadcast channels can be identified by a unique label, for example, a frequency modulation station name, television channel number, or cable channel number.

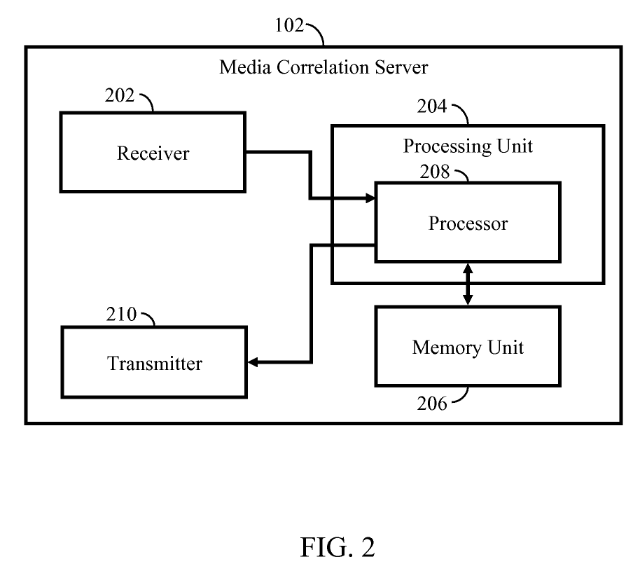

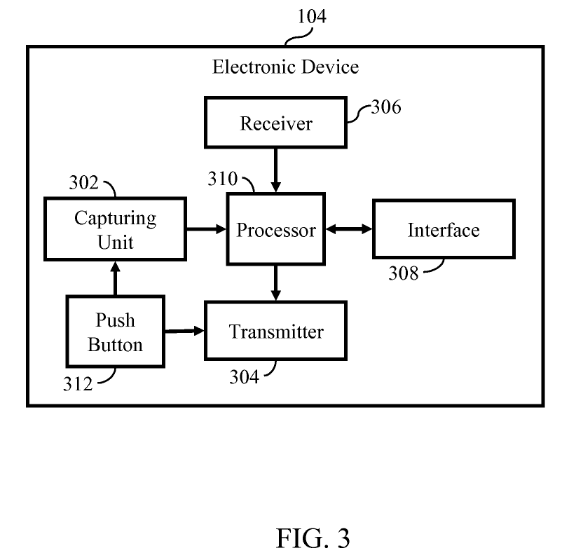

The electronic device 104 is capable of capturing an audio clip corresponding to a broadcast channel, for example, the broadcast channel 106 of the plurality of the broadcast channels. Further, the electronic device 104 can transmit the audio clip to a media correlation server, for example, the media correlation server 102. Examples of the media correlation server 102 include, but are not limited to, a real-time storage server, and a time-shift storage server. An example of a time-shift storage server is a media correlation server that stores popular programs that are often viewed by a user who stores a broadcast for later viewing. Examples of the electronic device 104 include, but are not limited to, mobile phones, Personal Digital Assistants (PDAs), Plain Old Telephones (POTs), Voice Over Internet Protocol (VOIP) phones, personal computers, laptops, notebook computers, cordless phones, Bluetooth™ headsets, handsfree sets, wired or wireless automobile car kits, internet tablets, portable music players, portable radio players, and universal remote-control devices. The media correlation server 102 is capable of capturing a plurality of audio segments from the plurality of broadcast channels. Further, the media correlation server 102 utilizes these audio segments to identify the broadcast channel, for example, the broadcast channel 106 on which the audio clip was broadcast. The detailed functioning of the media correlation server 102 and the electronic device 104 is described in conjunction with the FIG. 2 and FIG. 3, respectively.

FIG. 2 is a block diagram illustrating an exemplary media correlation server 102, in accordance with some embodiments of the present invention. The media correlation server 102 includes a receiver 202 and a processing unit 204. The receiver 202 is configured to receive an audio clip from an electronic device, for example, the electronic device 104. The receiver 202 is operatively coupled to the processing unit 204. The processing unit 204 is configured to capture a plurality of audio segments from a plurality of broadcasts corresponding to the plurality of broadcast channels. Further, the processing unit 204 identifies the broadcast channel on the basis of the plurality of audio segments and the audio clip. For an embodiment, the receiver 202 also receives a time stamp corresponding to the audio clip from the electronic device 104. In this embodiment, the processing unit 204 identifies the broadcast channel on the basis of the plurality of audio segments and the audio clip.

For an embodiment, the media correlation server 102 also includes a memory unit 206, a processor 208, and a transmitter 210. For an embodiment, the memory unit 206 temporarily stores one or more audio segments of the plurality of audio segments. For another embodiment, the memory unit 206 retains at least one audio segment of the plurality of audio segments. For example, a popular television or radio show, a popular song, and other such audio segments can be retained for a longer period of time or permanently. The processor 208, which is included in processing unit 204, is configured to correlate the audio clip with the plurality of audio segments, to determine the broadcast channel 106. The processor 208 can use any one of the several multi-channel correlation techniques to determine the broadcast channel.

The purpose of the multi-channel correlation techniques is to find the best match of the audio clip with one or more audio segments of the plurality of audio segments. For an embodiment, the multi-channel correlation is implemented by applying a cross correlation algorithm between the audio clip and each of the plurality of audio segments. An exemplary cross-correlation algorithm between the audio clip, for example, comprising N samples x(k), k=1 to N, and an audio segment, comprising M samples y(j), j=1 to M of the plurality of audio segments can be illustrated with help of the following equation in which the summation is from k=1 to N:

$$\text{?}$$

$$\text{?} \text{indicates text missing or illegible when filed}$$

The peak value r[n] of this cross correlation yields the most likely match both for the broadcast channel and the broadcast time. The peak value r[n] is calculated firstly across all values of n, which correspond to the time offset between the audio segment and the audio clip, and, then, across the plurality of audio segments. The exemplary correlation algorithm described in equation (1) is a simple algorithm, however, it will be readily apparent to those with ordinary skill in the art that variations of the above-mentioned method and/or more efficient algorithms can also be applied for the purpose of correlation.

More complex correlation algorithms based on pattern recognition methods can be used which extract features from both the plurality of audio segments and the audio clip. Details regarding one such algorithm can be found in a research paper titled ‘Computer Vision for Music Identification’ published in the IEEE Computer Society Conference on Computer Vision and Pattern Recognition, Volume 1, pp. 597-604, in 2005. However the fundamental merit of the proposed embodiment is that even very simple, computationally efficient cross correlation algorithms can be employed because the correlation is being performed against a relatively small set of reference audio segments specific to the time of the audio capture from 104.

For an embodiment, the processor 208 is also configured to generate metadata. The metadata is generated, based on the broadcast time and the broadcast channel. The broadcast time is the precise time the audio clip was broadcast on the broadcast channel 106. For an embodiment, the metadata is generated by the key-word recognition method. For example, one or more keywords of the broadcast from the broadcast channel 106 that were close to the broadcast time of the audio clip are recognized and used to create the metadata. Isolated word speech recognition techniques that are used for automatic generation of captions for broadcasts, based on key words being used in the broadcast, can be used for the purpose of keyword recognition and metadata generation.

For another embodiment, if the broadcast corresponding to broadcast channel 106 is accompanied by a close caption subtext, as with most terrestrial, satellite and cable television broadcasts, the close caption subtext can also be used to develop metadata.

For another embodiment, if the broadcast corresponding to the broadcast channel 106 is a frequency modulation radio broadcast, the accompanying Radio Data System (RDS) sub-carrier signal channel may contain information about broadcast program, phone number of the advertiser, details of the artist of the song, and details of the album of the song. This information can also be used to develop metadata for interactivity as envisioned by this invention.

For another embodiment, channel-information corresponding to the broadcast channel and the broadcast time is retrieved from a database. An example of the database includes, but is not limited to, an Electronic Program Guide. This channel-information is used to create the metadata. For an embodiment, automated image/video analysis techniques can also be applied when the broadcast channel 106 is a television channel, in conjunction with the key-word recognition techniques applied to the audio channel.

The metadata derived by any of the above-mentioned embodiments can be further improved by using Internet-based search techniques similar to those used for recognizing relevant key words for advertising on web pages. For an embodiment, the processor 208 is also configured to discard one or more of the plurality of audio segments after a predefined duration of time. For an embodiment all of the plurality of the audio segments can be discarded. The capability of the processor 208 to discard the audio segments after a predefined duration of time enables the invention to be implemented with very little memory space in the memory unit 206. For the purpose of this description, an exemplary way of reducing the required memory space is described. Consider an exemplary situation in which there are 1000 broadcast channels and the duration of the audio segments corresponding to each of the 1000 broadcast channels is 60 seconds. For the quality of audio segments required for correlation, the memory requirement is, for example, 2 Kilobytes (KB) per second of the audio segment. As a result, the total memory requirement for the 1000 channels would be only 120 Megabytes (MB) (1000 audio segments×60 seconds per audio segment×2 KB per second of the audio segment), since old audio are discarded after a predefined duration of time.

For another embodiment, all the audio segments of the plurality of the audio segments are not discarded, and at least one of the plurality of the audio segments is retained. For example, a popular television or radio show, a popular song, and other such audio segments can be retained for a longer period of time. Further, in this embodiment, when the receiver 202 receives an audio clip, which is recorded from a popular song that is not being played live, the processor 208 can identify the broadcast channel at which the popular song was previously played, based on the retained audio segments of the popular song stored in the memory 206. In some embodiments, in the instance of searching for a broadcast that was time-shifted (without the use of a time stamp), the process may be aided by the user identifying a generic class of broadcasts that are to be searched (e.g., this year's episodes of“Lost”).

The metadata generated by the processor 208 is transmitted by the transmitter 210 to one or more recipients. Examples of the recipients include, but are not limited to, audience monitoring service providers, advertisers, broadcasters, fulfillment channels, online merchants, catalog merchants, storefronts, and manufacturers of products.

For an embodiment, the transmitter 210 is also capable of transmitting context-sensitive information to the electronic device 104. This context-sensitive information is based on the broadcast time and the broadcast channel 106. Examples of the context-sensitive information include, but are not limited to, details of content being broadcast on the broadcast channel at the broadcast time, related content available from other venues, a time-synchronized subtext, a price of a product being advertised on the broadcast channel at the broadcast time, price of a product being promoted through product placement on the broadcast channel at the broadcast time, details of the product, an option to buy the product, and an option to seek further information.

FIG. 3 is a block diagram illustrating an exemplary electronic device 104, in accordance with some embodiments of the present invention. The electronic device 104 is shown to include a capturing unit 302, a transmitter 304, a receiver 306, an interface 308, and a processor 310. For an embodiment, the electronic device 104 also includes a push-button 312.

For an embodiment, the capturing 302 can be a microphone, which is capable of recording an audio clip of a broadcast corresponding to a broadcast channel, for example, the broadcast channel 106. For some embodiments, the capturing unit 302 is referred to as microphone 302. For an embodiment, the microphone 302 automatically records the audio clip periodically without human intervention. For another embodiment, the microphone 302 records the audio clip when the push-button 312 is pressed. The push-button 312 enables the microphone 302, and hence the electronic device 104, to capture the audio clip. For this embodiment, the microphone 302 can also record the audio clip from a time-shifted play back of an earlier broadcast.

For another embodiment, the capturing unit 302 is a broadcast-receiver, which is capable of receiving the broadcast. For some embodiments, the capturing unit 302 is referred to as broadcast-receiver 302. For this embodiment, the processor 310 is capable of directly filtering-out the audio clip from the broadcast that is being received by the broadcast-receiver 302, in response to a user command (i.e., a microphone is not used for the capture).

Thereafter, the capturing unit 302 sends the audio clip to the transmitter 304. The transmitter 304 transmits the audio clip to a predefined destination. For an embodiment, the predefined destination is the media correlation server 102. The transmitter 304 can transmit the audio clip via, for example, a voice call, circuit-switched data, cellular packet data, the Internet, Wireless Fidelity (WiFi), and Bluetooth™. For an embodiment, the transmitter 304 automatically transmits the audio clip to the predefined destination, for example, the media correlation server 102. For this embodiment, the transmitter 304 transmits the audio clip periodically. For another embodiment, the transmitter 304 transmits the audio clip to the media correlation server 102 when the push-button 312 is pushed.

The receiver 306 is capable of receiving context-sensitive information from the predefined destination, for example, the media correlation server 102. Examples of the context-sensitive information include, but are not limited to, details of content being broadcast on the broadcast channel at the broadcast time, related content available from other venues, time-synchronized subtext, price of a product being advertised on the broadcast channel at the broadcast time, price of a product being promoted through product placement on the broadcast channel at the broadcast time, details of the product, an option to buy the product, and an option to seek further information.

The interface 308 provides the context-sensitive information to a user of the electronic device 104. Examples of the interface 308 include, but are not limited to, an audio interface and a video interface. The interface 308 enables the user to use this context-sensitive information for several purposes, for example, buying the product, knowing the price of the product, knowing the price of product placement on the broadcast channel, and seeking further information about the product. For an embodiment, the processor 310 sends a purchase order for the product when the user opts to buy the product. The purchase order can be sent to the predefined destination, for example, the media correlation server 102, or to the one or more recipients of the metadata.

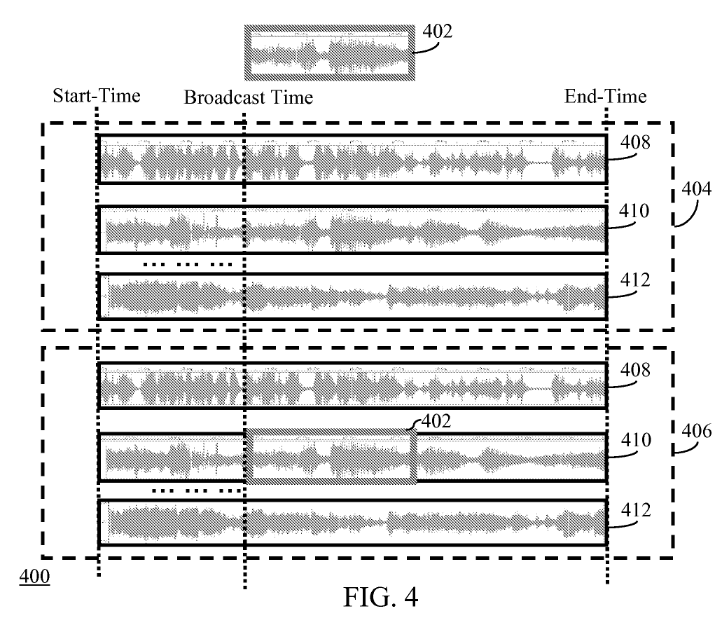

FIG. 4 is a chart 400 illustrating a correlation of the audio clip 402 with a plurality of audio segments 408, 410, and 412, in accordance with some embodiments of the present invention. For the purpose of this description, the chart 400 is shown to include two stages, namely, a first stage 404 and a second stage 406, to illustrate the correlation of the audio clip 402 with the plurality of audio segments, for example, audio segments 408, 410, and 412. For the purpose of this description, the duration of each of the plurality of audio segments 408, 410, and 412 is shown to span a start time of capturing the audio segments to an end time. For an embodiment, the duration of each of the plurality of audio segments is greater than a duration of the audio clip. For the purpose of this description, the duration of the audio segments 408, 410, and 412 is shown to be greater than the duration of the audio clip 402.

The first stage 404 shows the plurality of audio segments stored in the memory unit 206 of the media correlation server 102. When the audio clip 402 is received at the media correlation server 102 by the receiver 202, a time stamp associated with the audio clip 402 can also be received. The time stamp is indicative of an approximate time at which the audio clip 402 was recorded/filtered out from the broadcast, based on a clock of the electronic device where the audio clip 402 was captured, for example, the electronic device 104. In instances in which the audio clip is from a time-shifted playback of a broadcast, the time stamp may either be adjusted automatically by the playback device (when the audio clip is obtained directly from the device, without using a microphone) to indicate the approximate time at which the shifted audio clip was received by the recording device, or may be adjusted by a user input indicating the approximate amount of time shift. Thereafter, the audio clip 402 is correlated with each of the plurality of the audio segments to determine a broadcast channel corresponding to the audio clip 402. Further, since the duration of the audio segments 408, 410, and 412 is greater than that of the audio clip 402, the audio clip 402 can be correlated with the audio segments 408, 410, and 412 to identify the broadcast channel corresponding to the audio clip 402, even if there is slight variation in the clocks of the media server 102 and the electronic device 104.

Further, in an exemplary embodiment, the variation in the clocks is large or if there is delay in receipt of the audio clip 402 at the media correlation server 102, such that the audio segments corresponding to the audio clip have been discarded. For this embodiment, the processing unit 204 can retrieve the discarded audio segments to determine the precise time of broadcast of the audio clip 402.

The second stage 406 shows a result of the correlation of the audio clip 402. For the purpose of this description, the audio clip 402 is shown to correspond to the audio segment 410 in the result of the correlation. As a result, a broadcast channel at which the audio segment 410 was broadcast corresponds to the audio clip 402. For example, if the audio segment 410 was broadcast at the broadcast channel 106, the broadcast channel 106 corresponds to the audio clip 402. The precise time the audio clip 402 starts within the audio segment 410 is the broadcast time of the audio clip 402. In simple words, the precise time at which the audio clip 402 was broadcast on the broadcast channel 106 is the broadcast time of the audio clip 402.

Although, in FIG. 4, the audio clip 402 is shown to correspond to only one audio segment, for example, the audio segment 410, and consequently, to one broadcast channel, it will be readily apparent to those skilled in the art that the audio clip 402 can correspond to one or more additional broadcast channels. For this embodiment, the broadcast channel and the one or more additional broadcast channels are identified. Further, in this embodiment, the transmitter 210 transmits the context-sensitive information based on the broadcast channels and the one or more additional broadcast channels to the electronic device 104.

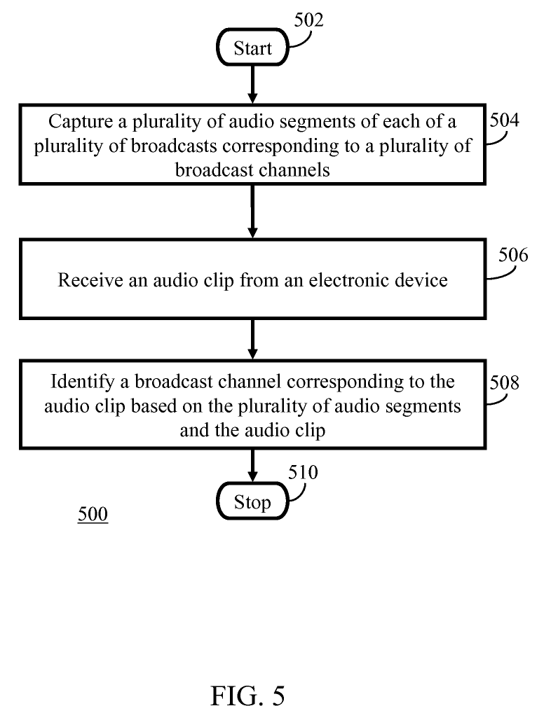

FIG. 5 is a flow diagram 500 illustrating a method for interactivity with broadcast media, in accordance with an embodiment of the present invention. To describe the flow diagram 500, reference is made to FIGS. 1, 2, 3, and 4, although it is understood that the flow diagram 500 can be implemented with reference to any other suitable embodiment of the invention. In addition, the flow diagram 500 can contain a greater or fewer number of steps than shown in FIG. 5.

At step 502 the method for interaction with the broadcast media is initiated. At step 504, a plurality of audio segments, for example, the audio segments 408, 410, and 412, are captured. The plurality of audio segments captured form a plurality of broadcasts that correspond to a plurality of broadcast channels. The audio segments are captured by the processing unit 204 in the media correlation server 102. At step 506, an audio clip, for example, the audio clip 402, is received from an electronic device, for example, the electronic device 104. The audio clip 402 is received by the receiver 202 in the media correlation server 102. At step 508, a broadcast channel corresponding to the audio clip, for example, the broadcast channel 106, is identified, based on the plurality of audio segments and the audio clip. The broadcast channel 106 is identified when a correspondence between the audio clip 402 and the broadcast channel 106 is already unknown. The broadcast channel 106 is identified by the processing unit 204 in the media correlation server 102. Thereafter, the method terminates at step 510. For another embodiment, when the correspondence between the audio clip 402 and the broadcast channel 106 is already known, the audio clip is associated with the broadcast channel 106. For example, when the media correlation server 102 already knows the broadcast channel, which the audio clip corresponds to, the processing unit 204 does not perform any additional calculation or apply any cross correlation algorithm to identify the broadcast channel. Instead, the processing unit 204 associates the broadcast channel with the audio clip to aid in generating the metadata and to retrieve the context-sensitive information.

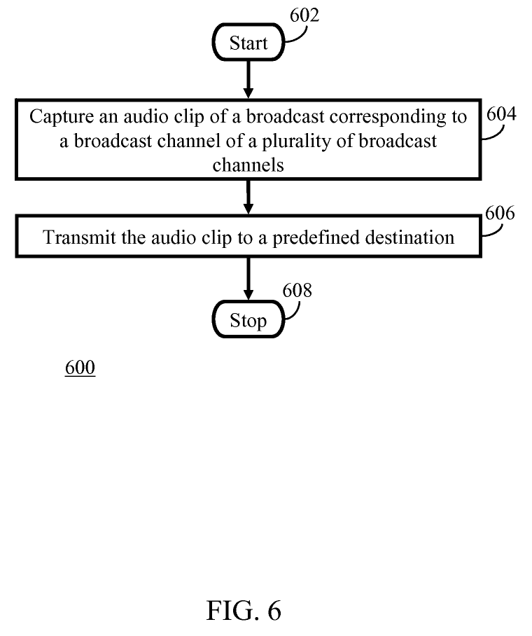

FIG. 6 is a flow diagram 600 illustrating a method for interactivity with the broadcast media, in accordance with another embodiment of the present invention. To describe the flow diagram 600, reference is made to FIGS. 1, 2, 3, and 4, although it is understood that the flow diagram 600 can be implemented with reference to any other suitable embodiment of the invention. In addition, the flow diagram 600 can contain a greater or fewer number of steps than shown in FIG. 6.

At step 602, the method for interactivity with the broadcast media is initiated. At step 604, an audio clip, for example, the audio clip 402, of a broadcast is captured. The broadcast corresponds to a broadcast channel of the plurality of broadcast channels. For example, the audio clip 402 corresponding to the broadcast channel 106 is captured. For an embodiment, the broadcast is a time shifted playback of an earlier broadcast.

Further, for an embodiment, the audio clip 402 is recorded when a push-button, for example, the push-button 312 of the electronic device 104, is pressed. In this embodiment, the capturing unit is a microphone, for example, the microphone 302. Further, the microphone 302 is a part of the electronic device 104. For another embodiment, a plurality of audio clips are automatically captured by the microphone 302.

For another embodiment, the audio clip 402 is filtered-out from the broadcast. In this embodiment, the capturing unit is a broadcast-receiver, for example the broadcast-receiver 302, which is continuously receiving the broadcast. Further, for an embodiment, the broadcast-receiver 302 can filter-out the audio clip 402 when the push-button 312 is pressed. For another embodiment, the plurality of audio clips are automatically filtered out by the broadcast-receiver 302

At step 606, the audio clip is transmitted to a predefined destination, for example, the media correlation server 102. For example, the audio clip 402 is transmitted by the transmitter 304 of the electronic device 104. For an embodiment, a time stamp associated with the audio clip 402 is also transmitted along with the audio clip. The time stamp carries information about the time when the audio clip 402 was captured.

For an embodiment, the method also includes receiving context-sensitive information from the predefined destination, for example, media correlation server 102. The context-sensitive information is based on the broadcast channel, for example, the broadcast channel 106 and the broadcast time. Thereafter, the method terminates at step 608.

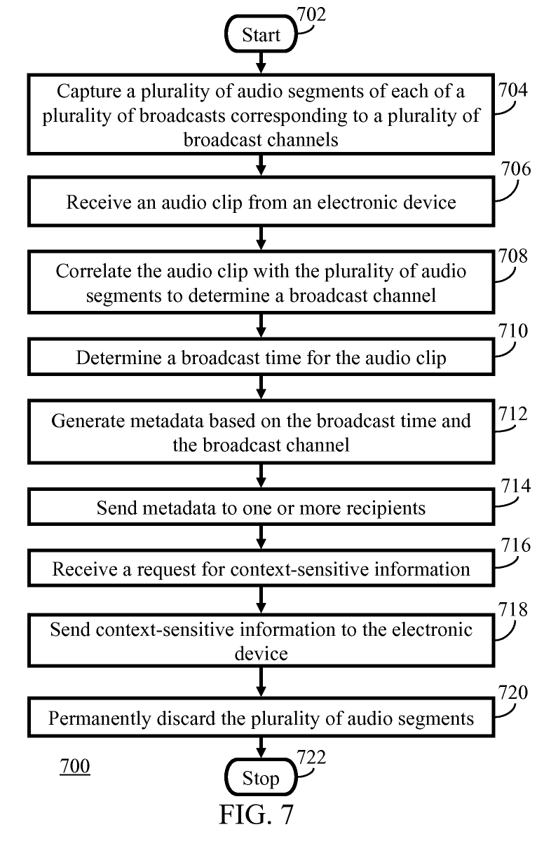

FIG. 7 is a flow diagram 700 illustrating a method for interactivity with the broadcast media, in accordance with yet another embodiment of the present invention. To describe the flow diagram 700, reference is made to FIGS. 1, 2, 3, and 4, although it is understood that the flow diagram 700 can be implemented with reference to any other suitable embodiment of the invention. In addition, the flow diagram 700 can contain a greater or fewer number of steps than shown in FIG. 7.

At step 702, the method for interactivity with the broadcast media is initiated. At step 704, a plurality of audio segments, for example, the audio segments 408, 410, and 412, are captured from a plurality of broadcasts that correspond to a plurality of broadcast channels. The audio segments are captured by the processing unit 204 of the media correlation server 102. At step 706, an audio clip, for example, the audio clip 402 is received at the media correlation server 102 from an electronic device, for example, the electronic device 104. Further, the receiver 202 of the media correlation server 102 receives the audio clip. For an embodiment, a time stamp associated with the audio clip 402 is also received along with the audio clip 402. At step 708, the plurality of audio segments are correlated with the audio clip, to determine a broadcast channel corresponding to the audio clip. For example, the plurality of audio segments 408, 410, and 412 are correlated with the audio clip 402 by the processing unit 204 of the media correlation server 102, to determine the broadcast channel 106. For an embodiment, a portion of each of the plurality of audio segments, for example, the audio segments 408, 410, and 412, is correlated with the audio clip 402. The portion of each of the audio segments is selected, based on the time stamp associated with the audio clip. For example, a portion of the audio segment is selected that starts before the time stamp and ends after the time stamp, with a predefined time span before and after the time stamp.

At step 710, a broadcast time corresponding to the audio clip, for example, the audio clip 402, is determined on the basis of the identification of the broadcast channel, as illustrated in description of FIG. 4. The broadcast time is determined by the processor 208 at the media correlation server 102.

At step 712, metadata is generated, based on the broadcast time and the broadcast channel, for example, the broadcast channel 106. This metadata is generated by the processor 208. For an embodiment, the metadata is generated by using the keyword-recognition method. For example, at least one keyword of the broadcast on the broadcast channel 106 is recognized and is used to create the metadata. For another embodiment, channel-information corresponding to the broadcast channel 106 and the broadcast time is retrieved from a database. An example of the database includes, but is not limited to, an Electronic Program Guide. This channel-information can be used to create the metadata.

At step 714, the metadata is sent to one or more recipients, for example, advertisers, broadcasters, fulfillment channels, online merchants, catalog merchants, storefronts, and manufacturers of a product, by the transmitter 210 of the media correlation server 102. The metadata can be used by the one or more recipients for several purposes such as to gauge the size of the audience, product promotion, information distribution, and service advertising. At step 716, a request is received for sending context-sensitive information to the electronic device, for example, the electronic device 104. For an embodiment, the request can be received from the one or more recipients of the metadata. Examples of the context-sensitive information include, but are not limited to, details of content being broadcast on the broadcast channel at the broadcast time, related content available from other venues, time-synchronized subtext, price of a product being advertised on the broadcast channel at the broadcast time, price of a product being promoted through product placement on the broadcast channel at the broadcast time, details of the product, an option to buy the product, and an option to seek further information. At step 718, the context-sensitive information is sent to the electronic device, for example, the electronic device 104. The context-sensitive information is sent by the transmitter 210 of the media correlation server 102. At step 720, one or more audio segments of the plurality of audio segments, for example, the audio segments 408, and 410 are discarded permanently after a predefined duration of time by the processor 208 of the media correlation server 102. Further, the audio segment 412 can be retained for a longer period of time or permanently. Thereafter, the method terminates at step 722.

As described above, various embodiments of the method for managing one or more objects in the communication network provide the following advantages. One advantage is real-time interactivity with the broadcast media provided by the invention. Further, a user of the electronic device, while listening to a broadcast on a radio or watching a broadcast on television, can press a push button to buy a product that was broadcast on the radio or television. Another advantage is that the invention can be implemented without any technical or commercial collaboration with the broadcasters of the broadcast channels. The correlation of the audio clip with the audio segments of the broadcasts is carried out by temporarily storing the audio segments in a memory unit. This eliminates the requirement of inserting inaudible signals in the broadcast content prior to the broadcast, as well as the need to collaborate with the broadcasters. Moreover, the present invention can be used advantageously for audience monitoring. The microphone automatically captures the audio clips of the broadcasts periodically, and transmits these audio clips to the media correlation server. At the media correlation server, broadcast channels corresponding to all the audio clips received periodically can be determined, and hence, the channel-watching and/or listening pattern of the user can be determined. For an embodiment, the plurality of audio segments are discarded after a predefined duration of time.

The method according to the present invention has several benefits compared to other approaches which seek to match an audio segment against a large database of previously stored audio, for example a database of millions of songs. Firstly, the computational complexity of matching each audio clip is significantly reduced since the match is being performed against far fewer audio samples, corresponding to the plurality of broadcast channels. For example, even in the case of 1000 broadcast channels, the order of computational complexity per match is 1000, where as the order of computational complexity per match in case of a data base of million songs is 1000000.

Secondly, the computational techniques that can be used for implementing the present invention are simple in nature. This enables the invention to be implemented with very little memory space.

It will be appreciated that embodiments of the invention described herein may be comprised of one or more conventional processors and unique stored program instructions that control the one or more processors, to implement, in conjunction with certain non-processor circuits, some, most, or all of the functions of the embodiments of the invention described herein. The non-processor circuits may include, but are not limited to, a radio receiver, a radio transmitter, signal drivers, clock circuits, power source circuits, and user input devices. As such, these functions may be interpreted as steps of a method for interactivity with broadcast media. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein. In those situations for which functions of the embodiments of the invention can be implemented using a processor and stored program instructions, it will be appreciated that one means for implementing such functions is the media that stores the stored program instructions, be it magnetic storage or a signal conveying a file. Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued. The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for interactivity with broadcast media, the method comprising:
capturing a plurality of audio segments from a plurality of broadcasts, the plurality of broadcasts corresponding to a plurality of broadcast channels;
receiving an audio clip from an electronic device; and
performing at least one of:
identifying at least one broadcast channel corresponding to the audio clip based on the plurality of audio segments and the audio clip and
identifying a broadcast channel corresponding to the audio clip from a known association of the broadcast channel with the audio clip.

2. The method according to claim 1, wherein identifying the at least one broadcast channel comprises correlating the audio clip with the plurality of audio segments to determine the at least one broadcast channel.

3. The method according to claim 1 wherein the known association is determined by receiving an identification of the broadcast channel with the audio clip.

4. The method according to claim 1 further comprising discarding one or more audio segments of the plurality of audio segments permanently after a predefined duration of time.

5. The method according to claim 1 further comprising
receiving a time stamp associated with the audio clip from the electronic device; and
wherein identifying the at least one broadcast channel corresponding to the audio clip is further based upon using the time stamp to select a portion of the plurality of audio segments.

6. The method according to claim 1 further comprising determining a broadcast time of the audio clip based on the identifying, wherein the broadcast time is a precise time when the audio clip was broadcast on the at least one broadcast channel.

7. The method according to claim 6 further comprising:
generating metadata based on the broadcast time and the at least one broadcast channel; and
providing the metadata to one or more recipients.

8. The method according to claim 7, wherein generating the metadata comprises:
recognizing at least one key-word of a content of at least one of the at least one broadcast channel; and
creating the metadata based on the at least one key-word.

9. The method according to claim 7, wherein generating the metadata comprises:
retrieving channel-information based on the at least one broadcast channel and the broadcast time, wherein the channel-information is retrieved from a database; and
creating the metadata based on the channel-information.

10. The method according to claim 7, wherein the one or more recipients are selected from the group comprising advertisers, broadcasters, fulfillment channels, online merchants, catalog merchants, storefronts, and manufacturers of a product.

11. The method according to claim 1 further comprising sending context-sensitive information to the electronic device, wherein the context-sensitive information is based on a broadcast time and the broadcast channel, wherein the broadcast time is a precise time when the audio clip was broadcast on the broadcast channel.

12. The method according to claim 11, wherein the context-sensitive information is selected from the group comprising details of a content being broadcast on the broadcast channel at the broadcast time, related content available from other venues, time synchronized subtext, price of a product being advertised on the broadcast channel at the broadcast time, price of a product being promoted through product placement on the broadcast channel at the broadcast time, details of the product, an option to buy the product, and an option to seek further information.

13. The method according to claim 1, wherein the plurality of broadcast channels are selected from the group comprising Amplitude Modulated (AM) radio channel, Frequency Modulated (FM) radio channel, Satellite Radio channel, iRadio channel, High Definition (HD) radio channel, on-air television broadcast, cable television, and satellite television.

14. A method for interactivity with broadcast media, the method comprising:
capturing an audio clip of a broadcast, the audio clip corresponding to at least one broadcast channel of a plurality of broadcast channels; and
transmitting the audio clip to a predefined destination.

15. The method according to claim 14, wherein the broadcast is a time-shifted playback of an earlier broadcast.

16. The method according to claim 14, wherein the capturing further comprises performing at least one of:
filtering-out by a processor the audio clip from the broadcast, wherein the broadcast is being received continuously; and
recording by a microphone the audio clip from the broadcast.

17. The method according to claim 14 further comprising transmitting a time stamp associated with the audio clip.

18. The method according to claim 14 further comprising receiving context-sensitive information from the predefined destination, wherein the context-sensitive information is based on a broadcast time and the at least one broadcast channel, wherein the broadcast time is a precise time when the audio clip was broadcast on the broadcast channel.

19. A media correlation server for interactivity with broadcast media, the media correlation server comprising:
a receiver capable of receiving an audio clip from an electronic device; and
a processing unit operatively coupled to the receiver, wherein the processing unit captures a plurality of audio segments from a plurality of broadcasts, the plurality of broadcasts corresponding to a plurality of broadcast channels and identifies at least one broadcast channel corresponding to the audio clip based on one of a known association between the audio clip and the at least one broadcast channel, and a correlation between the plurality of audio segments and the audio clip.

20. The media correlation server according to claim 19, wherein the processing unit comprises a processor configured to:
correlate the audio clip with the plurality of audio segments to determine the broadcast channel; and
determine a broadcast time of the audio clip based on the broadcast channel, wherein the broadcast time is a precise time when the audio clip was broadcast on the broadcast channel.

21. The media correlation server according to claim 19, wherein the processing unit comprises a processor capable of generating metadata, wherein the metadata is generated based on a broadcast time and the broadcast channel, and wherein the broadcast time is a precise time when the audio clip was broadcast on the broadcast channel.

22. The media correlation server according to claim 21 further comprising a transmitter capable of at least one of transmitting the metadata to one or more recipients, and transmitting context-sensitive information to the electronic device, wherein the context-sensitive information is based on the broadcast time and the broadcast channel.

23. The media correlation server according to claim 19, wherein the media correlation server is selected from the group comprising a real-time storage server, a time-shift storage server.

24. An electronic device for interactivity with broadcast media, the electronic device comprising:
a capturing unit to capture an audio clip of a broadcast corresponding to a broadcast channel of a plurality of broadcast channels; and
a transmitter configured to transmit the audio clip to a predefined destination.

25. The electronic device according to claim 24, wherein the capturing unit is selected from the group comprising a broadcast-receiver capable of receiving the broadcast and a microphone capable of recording the audio clip.

26. The electronic device according to claim 24, wherein the capturing device further comprises a clock function that generates a time stamp that is transmitted with the audio clip.
